(19) United States
(12) Patent Application Publication
(10) Pub. No.: US 2018/0114438 A1
(43) Pub. Date: Apr. 26, 2018

(54) LUMINAIRE PARKING GUIDANCE

(71) Applicant: PHILIPS LIGHTING HOLDING B.V., EINDHOVEN (NL)

(72) Inventors: RUBEN RAJAGOPALAN, NEUSS (DE); HARRY BROERS, S-HERTOGENBOSCH (NL)

(21) Appl. No.: 15/560,840

(22) PCT Filed: Mar. 11, 2016
(86) PCT No.: PCT/EP2016/055336

§ 371 Date: Sep. 22, 2017

(30) Foreign Application Priority Data
Mar. 23, 2015 (EP) 15160376.8

(51) Int. Cl. G08G 1/14; G08G 1/01

(52) U.S. Cl. CPC G08G 1/142; H05B 37/0227; G08G 1/01

(57) ABSTRACT

A luminaire comprising: a control module; at least one light source arranged to emit light to illuminate an outdoor environment of the luminaire; and a dimension supply module comprising a sensor module and configured to supply (i) dimensions of a vacant parking space in said environment to the control module; and (ii) dimensions of a vehicle approaching the vacant parking space to the control module, wherein the sensor module is configured to detect at least one of the dimensions of the vacant parking space and the dimensions of the vehicle; wherein the control module is configured to compare the dimensions of the vacant parking space and the dimensions of the vehicle to determine whether the vehicle is physically sized to fit in the vacant parking space, and if so, provide an alert that the vehicle is physically sized to fit in the vacant parking space.

### TECHNICAL FIELD

The present disclosure relates to providing assistance to drivers of vehicles when parking, and more specifically to a luminaire providing this assistance.

### BACKGROUND

Searching for a parking space is a routine (and often frustrating) activity for many people in cities around the world. As the global population continues to urbanize, without a well-planned, convenience-driven retreat from the car, these problems will worsen. Smart parking technologies have been emerging in the recent years to address this issue. It involves using low-cost sensors, real-time data collection, and mobile-phone-enabled automated payment systems that allow people to reserve parking in advance or very accurately predict where they will likely find a spot. When deployed as a system, smart parking thus reduces car emissions in urban centers by reducing the need for people to needlessly circle city blocks searching for parking. It also permits cities to carefully manage their parking supply. Within the entire amount of traffic overload that pours into large towns and cities, up to 30% consists of motorists searching for a place to park their car. To make matters worse, around 15% of parking spaces go unoccupied even at the busiest times—simply because drivers are unaware of the location of available spaces.

Various state-of-the-art smart real-time parking/metering systems and mobile applications exist, that require the setup of extensive sensor, communication and data-analytics infrastructure.

An example of a state-of-the-art smart parking solution is shown in FIG. 1. This solution incorporates occupancy sensors (RF/IR/Magnetic) that are placed or buried into the road surface, that communicate to external 3^{rd} party systems via their RF infrastructure.

Also known in the art are parking assistance systems (often referred to as Advanced Driver Assistance Systems (ADAS)) that are implemented in vehicles to provide audio-visual guidance to the driver inside the vehicle alerting the driver of possible dangerous collisions/obstacles, as shown in FIG. 2.

### SUMMARY

The inventors have identified that whilst in-vehicle parking systems exist, these will not be available to all road users and the state-of-the-art smart parking solutions fail to take into consideration the dimensions/volume of approaching vehicles to inform the road users intuitively if the vacant parking spaces are still optimal/suitable for parking.

In embodiments of the present disclosure there is provided a luminaire that is integrated with vision solutions that detect the volume/dimensions of approaching vehicles and automatically provide visual indication/signaling if the vehicle fits the vacant space that is within the luminaire's footprint. In embodiments of the present disclosure there is provided a luminaire that is integrated with identification solutions that detect the identity of approaching vehicles and determine whether the vehicles are authorized to park within the vacant space that is within the luminaire's footprint.

According to one aspect of the present disclosure there is provided a luminaire comprising: a control module; at least one light source arranged to emit light to illuminate an outdoor environment of the luminaire; and a dimension supply module comprising a sensor module and configured to supply (i) dimensions of a vacant parking space in said environment to the control module; and (ii) dimensions of a vehicle approaching the vacant parking space to the control module, wherein the sensor module is configured to detect at least one of the dimensions of the vacant parking space and the dimensions of the vehicle; wherein the control module is configured to compare the dimensions of the vacant parking space and the dimensions of the vehicle to determine whether the vehicle is physically sized to fit in the vacant parking space, and if so, provide an alert that the vehicle is physically sized to fit in the vacant parking space.

The sensor module may comprise one or any combination of: at least one three-dimensional camera; at least one two-dimensional camera; and at least one thermal imaging camera.

The sensor module may further comprise an Anisotropic MagnetoResistance sensor configured to detect the dimensions of the vehicle.

The dimension supply module may comprise a network interface for reception over a communication network of at least one of the dimensions of the vacant parking space and the dimensions of the vehicle.

The dimension supply module may comprise a memory storing the dimensions of the vacant parking space.

The dimension supply module may comprise a memory storing the dimensions of the vehicle.

The network interface may comprise a wireless network interface, and the control module may be configured to provide the alert by transmission of a signal via a wireless communication network to the vehicle or a mobile device associated with a user of the vehicle.

The control module may be configured to provide the alert by controlling the light emitted from the at least one light source to visually indicate that the vehicle is physically sized to fit in the vacant parking space.

The control module may be configured to control a colour of the light emitted from the at least one light source to visually indicate that the vehicle is physically sized to fit in the vacant parking space.

The control module may be configured to control an intensity of the light emitted by the at least one light source to visually indicate that the vehicle is physically sized to fit in the vacant parking space.

The control module may be configured to increase the intensity of the light emitted by the at least one light source to visually indicate that the vehicle is physically sized to fit in the vacant parking space.

The control module may be configured to control the intensity of the light emitted by the at least one light source in accordance with a predetermined blinking pattern to visually indicate that the vehicle is physically sized to fit in the vacant parking space.

The dimension supply module may be configured to supply identification information for the vehicle approaching the vacant parking space and authorization information for the vehicle approaching the vacant parking space to the control module. The sensor module may be configured to detect the identification information.

The control module may be configured, in response to a determination that the vehicle is not physically sized to fit in the vacant parking space, to provide an alert that the vehicle is not physically sized to fit in the vacant parking space.

The control module may be configured to detect a potential collision between the vehicle and an object in the outdoor environment of the luminaire, and in response, provide an alert of the potential collision.

According to another aspect of the present disclosure there is provided a street light comprising a pole and the luminaire according to any of the embodiments described herein.

According to another aspect of the present disclosure there is provided a luminaire comprising: a control module; at least one light source arranged to emit light to illuminate an outdoor environment of the luminaire; and a dimension supply module comprising a sensor module and configured to supply (i) identification information for a vehicle approaching a vacant parking space; and (ii) authorization information for the vehicle approaching the vacant parking space to the control module, wherein the sensor module is configured to detect the identification information; wherein the control module is configured to determine whether the identified vehicle is authorized to park in the vacant parking space, and if so, provide an alert that the vehicle is authorized to park in the vacant parking space.

The dimension supply module may comprise a network interface for reception over a communication network of at least one of the identification information and the authorization information for the vehicle.

The control module may be configured provide to the alert by controlling the light emitted from the at least one light source to visually indicate that the vehicle is authorized to park in the vacant parking space.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 illustrates a prior art smart parking solution;

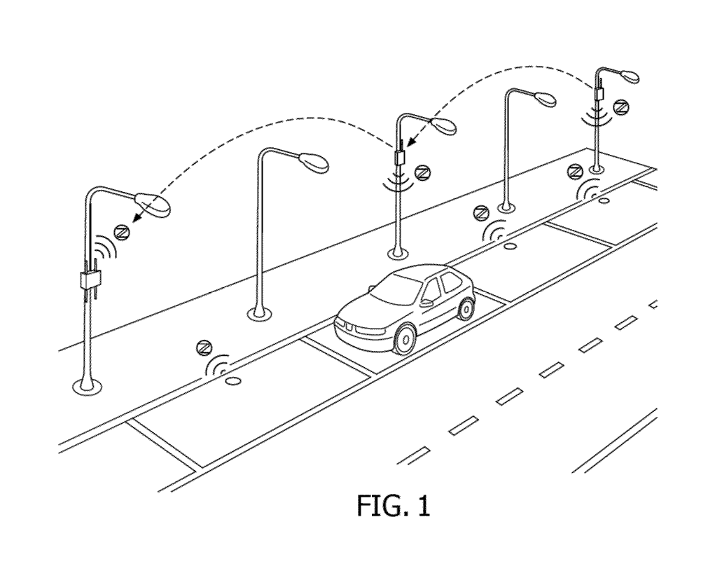

FIG. 2 illustrates a prior art in-vehicle parking assistance system;

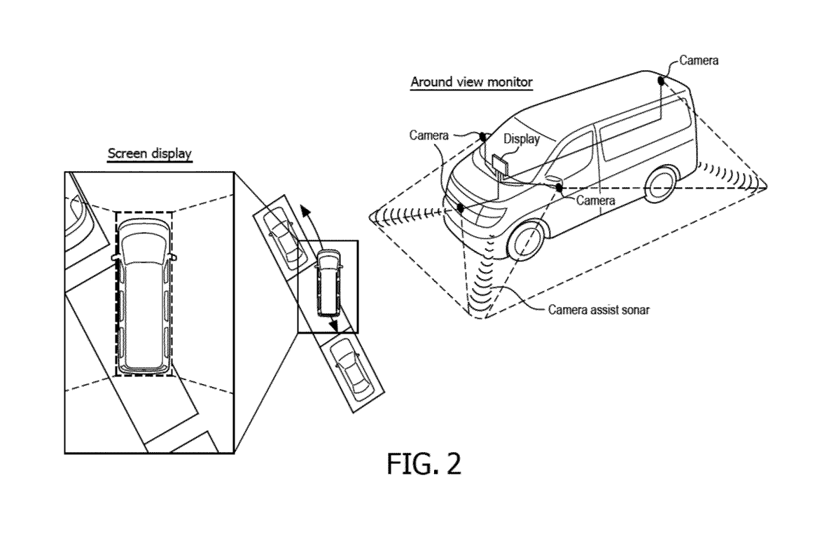

FIG. 3 is a schematic block diagram of a luminaire;

FIG. 4 illustrates an image recognition process;

FIG. 5 illustrates detection of parking space dimensions.

FIG. 6 illustrates an outdoor street light comprising the luminaire; and

FIG. 7 is a flowchart of a method to provide an alert as to whether a vehicle is physically sized to fit in a vacant parking space.

FIG. 8 is a schematic block diagram of a parking system.

FIG. 9 is a flowchart of a method to provide an alert as to whether a vehicle is authorized to park in a vacant parking space.

### DETAILED DESCRIPTION

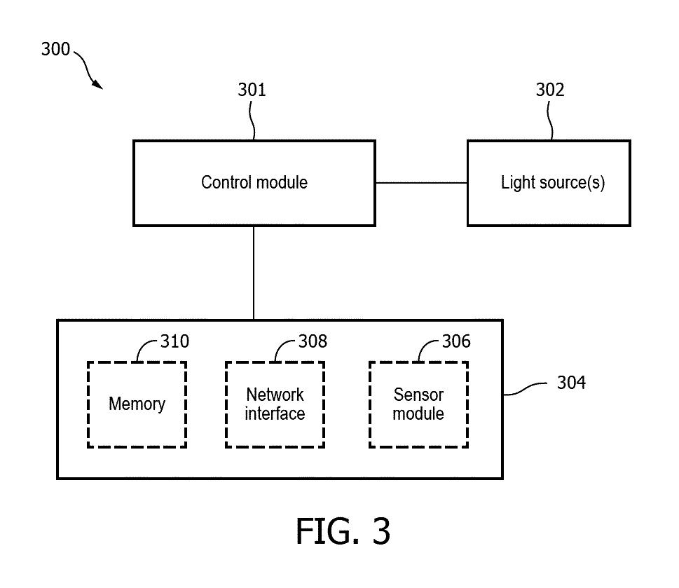

Reference is first made to FIG. 3 which illustrates a schematic block diagram of a luminaire 300.

The luminaire 300 comprises a control module 301 that is coupled to a dimension supply module 304 and one or more lighting source 302 that are operable to emit light to illuminate an environment of the luminaire 300.

The light source(s) 302 may comprise any suitable source of light such as e.g. a high/low pressure gas discharge source, a laser diode, an inorganic/organic light emitting diode (LED), an incandescent source, or a halogen source. A light source may be a single light source, or could comprise multiple light sources, e.g. multiple LEDs which may, for example, form an array of light sources collectively operating as a single light source. The light source(s) 302 are controllable in that the light emitted by the light source(s) 302 is controlled by the control module 301.

The control module 301 is configured to control the light emitted from the light source(s) 302 by transmitting appropriate control signals to the light source(s) 302. The functionality of the control module 301 may be implemented in code (software) stored on a memory comprising one or more storage media, and arranged for execution on a processor comprising on or more processing units. The code is configured so as when fetched from the memory and executed on the processor to perform operations in line with embodiments discussed below. Alternatively it is not excluded that some or all of the functionality of the control module 301 is implemented in dedicated hardware circuitry, or configurable hardware circuitry like a field-programmable gate array (FPGA).

The control module 301 is configured to control the light emitted from the light source(s) 302 in response to input signals received from the dimension supply module 304.

In accordance with embodiments of the present disclosure the dimension supply module 304 is configured to supply (i) dimensions of a vacant parking space in the environment of the luminaire 300 to the control module 301; and (ii) dimensions of a vehicle approaching the vacant parking space to the control module 301.

The dimension supply module 304 may obtain each of the dimensions of the vacant parking space in the environment of the luminaire 300 and the dimensions of a vehicle approaching the vacant parking space to the control module 301 by various means. These are discussed in more detail below.

The dimension supply module 304 may comprise a sensor module 306. The sensor module 306 comprises at least one sensor.

The sensor module 306 enables detection of the dimensions of a vacant parking space in the environment of the luminaire 300 and/or detection of dimensions of a vehicle approaching the vacant parking space.

The sensor module 306 may comprise one or more optical sensor for example at least one two-dimensional (2D) and/or at least one three-dimensional (3D) camera and/or at least one thermal imaging camera, with an integrated image processing component that executes an algorithm to perform image processing on images captured by the camera.

The integrated image processing component of the camera operates in accordance with known vision sensor techniques like motion segmentation and object recognition. The integrated image processing component of the camera is configured to continually update a model of the scene and every time a new object (e.g. a vehicle) enters into the sensing region (otherwise referred to herein as a field of view “FOV”) of the camera, the image processing component of the camera recognises that it is new in the scene and identifies a need to track it which comprises tracking the co-ordinates of the moving object in its image co-ordinate space, and the physical size of the object.

Dimensions of a vacant parking space and the location and physical size of the vehicle can be derived from 2D, 3D or thermal images.

A passive 2D Camera can be used to detect the dimensions of a vacant parking space in the environment of the luminaire 300 and/or to detect the dimensions of a vehicle approaching the vacant parking space. In particular these dimensions can be obtained by applying image processing to captured 2D images.

A parking space in the FOV of the passive 2D camera can be detected based on pixel intensities in an image captured by the passive 2D camera. This parking space may be detected by the integrated image processing component of the passive 2D camera based on pixel intensities of road markings defining the parking space in a captured image, or on pixels intensities of a region between objects (e.g. other vehicles, buildings etc.) in a captured image if road markings defining the parking space are not present.

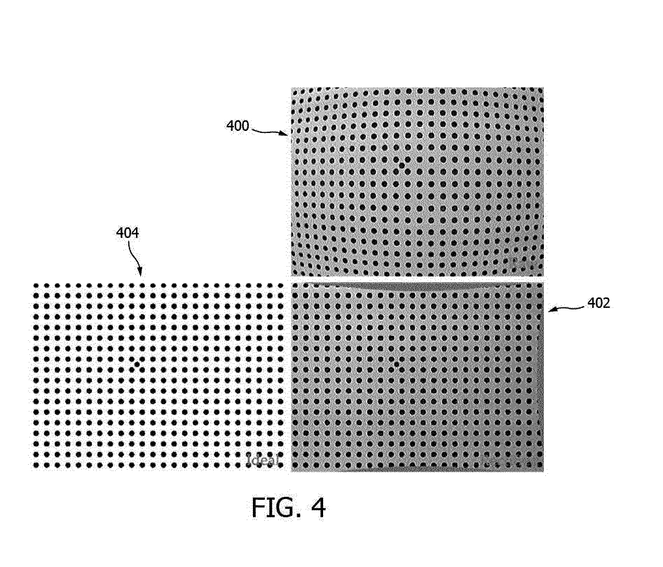

Parking space and vehicle dimensions can be derived from pixel information only. An example shown in FIG. 4 shows typical image rectification, illustrating the deformation of a reference grid (whereby the camera image plane is parallel to the reference grid), as seen by the camera's raw image 400, and the reconstruction done based on intrinsic camera information (e.g. parameters defining the camera lens and imager, for example focal length, image sensor format, principal point and lens distortion etc.) to provide a rectified image 402. FIG. 4 illustrates the ideal camera image 404 for comparison. In this manner, the coordinates of the parking space can be used to quantify the dimension in pixels, and the coordinates of the object being tracked can be matched relative to this to verify if it fits within the space.

Also, camera rotations can be compensated to create an isometric pixel map when the pose is known. The approach is completely unaware of dimensions in meters.

If both the vehicle and parking space are visible in the field of view of the 2D camera, a determination on whether the vehicle is physically sized to fit in the vacant parking space can be based on only pixel information. Thus, metric information and therefore extrinsic parameters are not required.

In scenarios where metric information is required to make the determination, extrinsic camera parameters can be used to translate the pixels into metric information (e.g. to translate camera coordinates into real world coordinates). For example given the camera's height relative to the ground or the dimensions of the parking place, the pixel information can be translated into meters. Extrinsic camera parameters (location/orientation) can be known a priori (e.g. configuration during installation) or derived from the scene itself.

In a scenario whereby the sensor module 306 comprises the 2D camera (the sensor is integrated into the luminaire 300). In most cases the luminaire 300 and thus embedded sensor are mounted parallel to the road surface. In this case, the luminaire height is the only relevant unknown extrinsic parameter. This missing parameter can be provided to the sensor during installation when the mounting height is known. From the deformation of the parking space in the camera the orientation of the sensor to the ground plane can be retrieved. However, the size of the parking space cannot be determined without heuristics if the camera height is unknown. If the parking space dimensions are provided, the camera height can be deduced so that all extrinsic parameters are known

Based on detecting the parking space in a captured image, the integrated image processing component is able to detect a skewed polygon defining the parking space, and using known image processing techniques (e.g. pose estimation) determine the passive 2D camera's perspective towards the real world polygon in order to translate an observed amount of pixels in its image co-ordinate space defining the dimensions of the skewed polygon to provide an output signal indicative of the dimensions of the parking space in metres.

By processing multiple images captured by the passive 2D camera, the image processing component of the passive 2D camera can detect when an object (e.g. vehicle) enters into its FOV, and track the pixel intensities of the vehicle over the multiple images. Vehicle occupancy of the parking space can be detected by the integrated image processing component of the passive 2D camera by detecting if pixel intensities of an object being tracked (e.g. a vehicle) occlude the pixel intensities in the previously unoccupied parking space region.

Processing multiple images captured by a single 2D camera may be necessary as occlusions may be present in a single image captured by the 2D camera. That is, in order to accurately determine the dimensions of the vehicle, processing of multiple frames comprising the vehicle is needed to solve all of the ambiguities arising due to occlusions (similar to shape carving method for volume reconstruction).

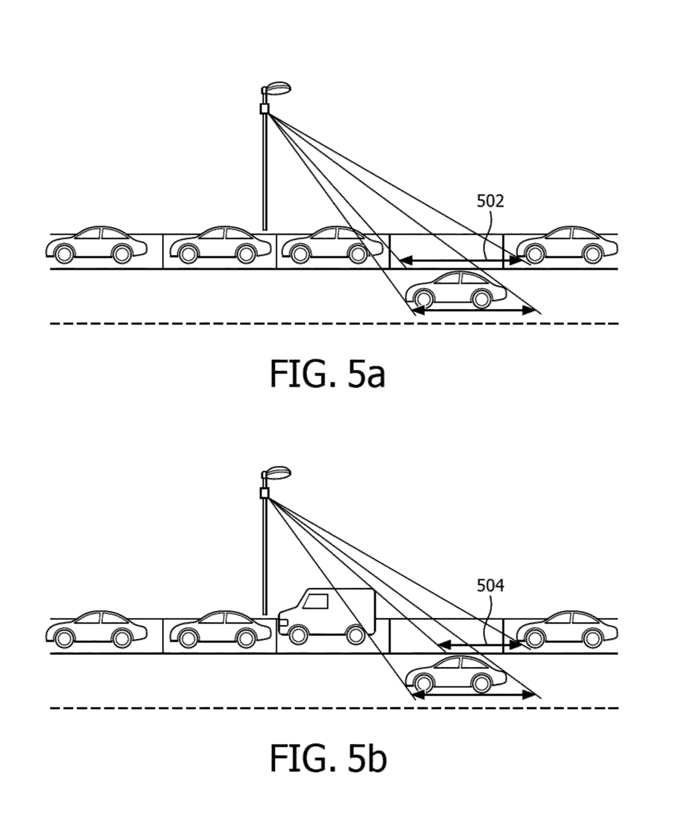

Accurate detection of the dimensions of a vacant parking space in the environment of the luminaire 300 using 2D images due to the occlusions referred to above without knowing the geometry of the vehicles in the vicinity of the parking space may be problematic. FIG. 5a illustrates a situation with low height vehicles parked around a vacant parking space which results in a detection of the parking space having a length 502. FIG. 5b illustrates a similar situation with a high height vehicle parked in front of the vacant parking space which results in a detection of the parking space having a length 504. As shown in FIGS. 5a and 5b, the height difference results in a detection of different vacant parking space dimensions.

To improve accuracy of the detection dimensions of a vacant parking space, the image processing component of the 2D camera may perform image recognition to detect vehicle type (e.g. car, van, truck etc.). The sensor module 306 may comprise a memory storing reference vehicle dimensions for each of the detectable vehicle types. Thus once the vehicle type is detected, the sensor module 306 can query the memory for vehicle dimensions associated with the detected vehicle type.

The sensor module 306 may comprise multiple 2D cameras having different orientations with respect to each other. Persons skilled in the art will appreciate that processing of the images captured by the multiple 2D camera may enable the ambiguities arising due to occlusions to be resolved without processing multiple frames captured by each of the multiple 2D cameras. Furthermore a depth image of the scene can be obtained based on images captured by the multiple cameras due to the known orientation relationship between the multiple cameras.

A thermal imaging camera can be used to detect the dimensions of a vacant parking space in the environment of the luminaire 300 and/or to detect the dimensions of a vehicle approaching the vacant parking space. Instead of having the pixel information coming from light reflection, a thermal imaging camera converts heat into pixel data. After this step known 2D vision algorithms can detect the presence of a vehicle and its dimensions using its heat signature. A 3D camera can be used to detect the dimensions of a vacant parking space in the environment of the luminaire 300 and/or to detect the dimensions of a vehicle approaching the vacant parking space. In particular these dimensions can be obtained by applying image processing to captured depth-aware images. It will be appreciated by persons skilled in the art, that use of a 3D camera may be able to provide more accurate dimension estimation compared with a passive 2D Camera.

As will be apparent to persons skilled in the art, various 3D range sensing modalities exist that enable extraction of 3D information. One example technique to extract 3D information is use of the time-of-flight principle. A 3D time-of-flight camera comprises a time-of-flight sensing element. The time-of-flight sensing element is able to sense radiation emitted from an emitter, and this sensing is synchronised with the emission of the radiation from the emitter. The emitter may be a dedicated emitter which may be part of the 3D time-of-flight camera. In this case the emitted radiation may be radiation other than visible light, e.g. infrared, RF or ultrasound, in order not to intrude upon or be confused with the visible light emitted by the light source(s) 302; or the radiation could be visible light modulated with an identifiable signal to distinguish it from the rest of the light in the environment of the luminaire 300. Alternatively the radiation used in the time-of-flight sensing may be from the by the light source(s) 302 which are already emitting visible light into the environment of the luminaire 300 for the purpose of illumination.

Some of the emitted radiation will be reflected back towards the 3D time-of-flight camera. As it is synchronised with the emission, the time of flight sensor can be used to determine the amount of time between emission from the emitter and reception back at the sensing element, i.e. time-of-flight information. Further, the sensing element takes the form of a two-dimensional pixel array, and is able to associate a time-of-flight measurement with a measurement of the radiation captured by some or all of the individual pixels. Thus the time-of-flight sensor is operable to capture a depth-aware or three-dimensional image in its sensing region (often referred to as a field of view). Details of time-of-flight based image sensing in themselves will be familiar to a person skilled in the art, and are not described in any further detail herein.

Whilst a 3D time-of-flight camera has been described above this is merely an example, the 3D camera may be a laser scanner or structured light camera (based on the active triangulation principle known in the art), matrix array camera, or any other sensor capable of extracting 3D information.

A 3D camera, like the passive 2D passive camera described above has its own 2D passive intensity measurement which can be used to detect a parking space in the FOV of the 3D camera based on pixel intensities in an image captured by the 3D camera. This parking space may be detected by the integrated image processing component of the 3D camera based on pixel intensities of road markings defining the parking space in a captured image, or on pixels intensities of a region between objects (e.g. other vehicles, buildings etc.) in a captured image if road markings defining the parking space are not present.

To detect occupancy of the parking space in the FOV of the 3D camera, the 3D camera looks at the flat road surface and estimates the height/distance to the surface and determines whether the space occupied or not based on this estimated distance. That is, the 3D camera obtains a depth map using measured depth information, and is able to determine that the parking space is unoccupied if the depth map is flat within the detected parking space.

By processing multiple images captured by the 3D camera, the image processing component of the passive 2D camera can detect when an object (e.g. vehicle) enters into its FOV, and track the pixel intensities of the vehicle and the depth information over the multiple images to determine the dimensions of the vehicle.

Processing multiple images captured by a single 3D camera may be necessary as occlusions may be present in a single depth image captured by the 3D camera. That is, in order to accurately determine the dimensions of the vehicle, processing of multiple frames comprising the vehicle is needed to solve all of the ambiguities arising due to occlusions.

The sensor module 306 may comprise multiple 3D cameras having different orientations with respect to each other. Persons skilled in the art will appreciate that processing of the images captured by the multiple 3D camera may enable the ambiguities arising due to occlusions to be resolved without processing multiple frames captured by each of the multiple 3D cameras.

The sensor module 306 may comprise one or more magnetic sensor for example a field-effect sensor such as a 3-axis Anisotropic MagnetoResistance (AMR) sensor. This type of magnetic sensor can be used to detect the dimensions of a vehicle approaching a vacant parking space in the environment of the luminaire 300.

The resistance of an AMR sensor changes according to the Earth's magnetic field strength. Road vehicles typically have significant amounts of ferrous metals. Since the magnetic permeability of these ferrous metals is higher than the surrounding air, a vehicle can concentrate the flux lines of the Earth's magnetic fields. Magnetic signatures detected by a 3-axis AMR sensor can be used to distinguish between different types of vehicle (e.g. car, bus, truck etc.). The sensor module 306 may comprise a memory storing reference vehicle dimensions for each of the detectable vehicle types. Thus once the vehicle type is detected, the sensor module 306 can query the memory for vehicle dimensions associated with the detected vehicle type.

Whilst use of an AMR sensor may not achieve the level of granularity of dimension estimates achievable with a passive 2D Camera or a 3D camera, this sensor modality is still able to provide a usable form of vehicle dimension estimate.

The dimension supply module 304 may comprise a network interface 308. The network interface 308 enables connection to a wired communication network via a cable (wired) connection and/or enables connection to a wireless communication network via a wireless connection. The communications network may be for example a local wired network, local wireless network (e.g. based on a short-range RF technology such as Wi-Fi or ZigBee network), or a wired or wireless wide area network or internetwork, such as the Internet or a cellular mobile phone network (e.g. 3GPP network).

The network interface 308 enables the dimensions of the vacant parking space in the environment of the luminaire 300 and/or the dimensions of a vehicle approaching the vacant parking space to be received from sensors that are external to the luminaire 300 but are connected to the luminaire by way of a wired or wireless connection.

For example, the network interface 308 enables dimensions of the vehicle approaching the vacant parking space that are transmitted by a transmitter on the vehicle to be received by the luminaire 300.

Rather than the actual dimensions of the vehicle being received via the network interface 308, an identifier of the vehicle type of the vehicle approaching the vacant parking space may be received via the network interface 308 and dimensions of the vehicle extracted by querying a memory storing vehicle type identifiers associated with respective vehicle dimensions.

The dimension supply module 304 may comprise a memory 310. The memory 310 may store the dimensions of a parking space in the environment of the luminaire 300 or the dimensions of a vehicle approaching the parking space that have been manually entered by an installer of the luminaire 300.

The luminaire 300 may be embodied in a number of different structures.

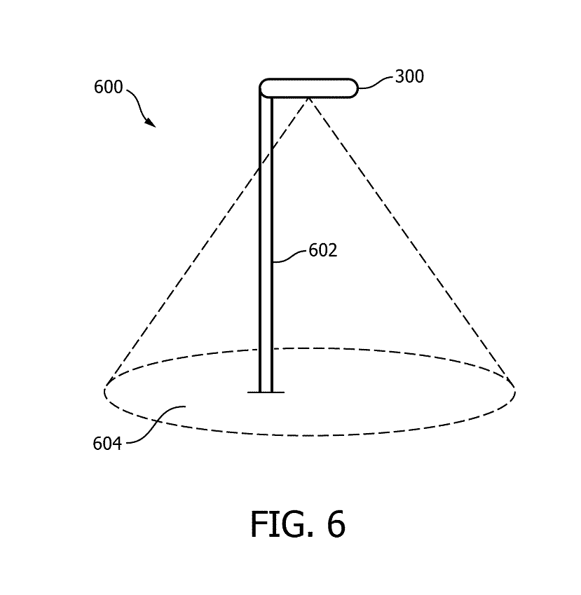

For example, the luminaire 300 may be a part of a street light that is arranged to provide illumination to a car park, road, highway or other road infrastructure. FIG. 6 illustrates a street light 600 comprising a pole 602 and the luminaire 300, whereby the luminaire 300 is suitably mounted to the pole 602. The pole 602 is a supporting structure that elevates the luminaire 300 to a height off the ground, such that the light source(s) 302 of the luminaire 300 provide illumination in the vicinity of the street light. The light footprint 604 of the light source(s) 302 of the luminaire 300 is shown in FIG. 6. The light footprint 604 is not limited to being circular, although it can be.

In these example described above, the dimension supply module 304 may comprise a memory 310 storing the dimensions of the parking space in the environment of the luminaire 300 that have been manually entered by an installer of the street light 400.

In another example, the luminaire 300 may be integrated into a vehicle forming a headlight or taillight of the vehicle. In this example, the dimension supply module 304 may comprise a memory 310 storing the dimensions of the vehicle that have been manually entered by a person during or after manufacture of the vehicle.

In another example, the luminaire 300 may be integrated into a traffic cone or other reflective road marker that is used for traffic re-routing, construction work areas etc.

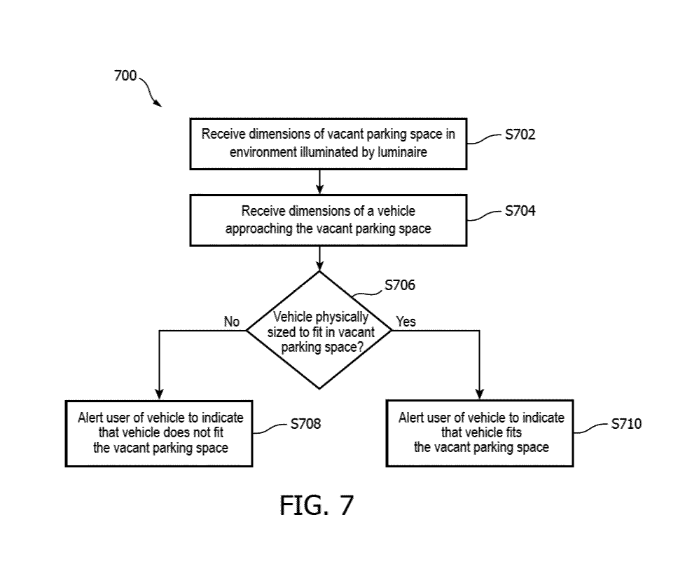

FIG. 7 is a flowchart for a process 700 performed by the control module 301. At step S702, the control module 301 receives dimensions of a vacant parking space in the environment of the luminaire 300.

The control module 301 may receive the dimensions of the vacant parking space based on a signal received from the sensor module 306. The signal received from the sensor module 306 being indicative of the dimensions of the vacant parking space.

Alternatively, the control module 301 may receive the dimensions of the vacant parking space based on a signal received from the network interface 308. The signal received from the network interface 308 being indicative of the dimensions of the vacant parking space.

Alternatively, the control module 301 may receive the dimensions of the vacant parking space based on transmitting a query to memory 310, and in response receiving the dimensions of the vacant parking space from the memory 310.

At step S704, the control module 301 receives dimensions of a vehicle approaching the vacant parking space in the environment of the luminaire 300.

The control module 301 may receive the dimensions of the vehicle approaching the vacant parking space based on a signal received from the sensor module 306. The signal received from the sensor module 306 being indicative of the dimensions of the vehicle.

Alternatively, the control module 301 may receive the dimensions of the vehicle approaching the vacant parking space based on a signal received from the network interface 308. The signal received from the network interface 308 being indicative of the dimensions of the vehicle.

Alternatively, the control module 301 may receive the dimensions of the vehicle approaching the vacant parking space based on transmitting a query to memory 310, and in response receiving the dimensions of the vehicle from the memory 310. For example, when the luminaire 300 is integrated into the vehicle as described above.

At step S706, the control module 301 compares the dimensions of the vacant parking space and the dimensions of the vehicle to determine whether the vehicle is physically sized to fit in the vacant parking space.

To allow for a parking manoeuvre to be performed by the driver of vehicle, this comparison may comprise the control module 301 determining whether the length of the vehicle multiplied by a predetermined factor is less than or equal to the length of the vacant parking space, and determining whether the width of the vehicle multiplied by a predetermined factor is less than or equal to the width of the vacant parking space. It will be appreciated that this is merely an example and the comparison performed at step S706 may perform additional or alternative calculations than those described above.

If the control module 301 determines, based on the comparison at step S706, that the vehicle is physically sized to fit in the vacant parking space the process 700 proceeds to step S710, otherwise the process proceeds to step S708.

At step S710, the control module 301 provides an alert (e.g. to a driver of the vehicle) that the vehicle is physically sized to fit in the vacant parking space.

At step S710 the control module 301 may control the light emitted from the light source(s) 302 to visually indicate that the vehicle is physically sized to fit in the vacant parking space.

At step S710, the control module 301 may control the colour (hue) of the light emitted by the light source(s) 302. For example, the control module 301 may control the light source(s) 302 such that they emit green light. The control module 301 may control the light source(s) 302 by varying the colour temperature of the light emitted by the light source(s) 302. Alternatively or additionally, at step S710 the control module 301 may control the intensity of the light emitted by the light source(s) 302. For example, the control module 301 may increase the intensity of the light emitted by the light source(s) 302, or control the light source(s) 302 to emit light in accordance with a blinking pattern (whereby one or more of the light source(s) 302 the lights blink on and off in a pattern for a predetermined period of time) indicating that the vehicle is physically sized to fit in the vacant parking space.

Embodiments of the present disclosure extend to other methods of controlling the light emitted by the light source(s) 302 that are not described herein to provide the alert that the vehicle is physically sized to fit in the vacant parking space.

At step S708, the control module 301 may control the light emitted from the light source(s) 302 to visually indicate that the vehicle is not physically sized to fit in the vacant parking space.

At step S708, the control module 301 may control the colour (hue) of the light emitted by the light source(s) 302. For example, the control module 301 may control the light source(s) 302 such that they emit red light. The control module 301 may control the light source(s) 302 by varying the colour temperature of the light emitted by the light source(s) 302. Alternatively or additionally, at step S708 the control module 301 may control the intensity of the light emitted by the light source(s) 302. For example, the control module 301 may decrease the intensity of the light emitted by the light source(s) 302, or control the light source(s) 302 to emit light in accordance with a blinking pattern indicating that the vehicle is not physically sized to fit in the vacant parking space

Embodiments of the present disclosure extend to other methods of controlling the light emitted by the light source(s) 302 that are not described herein to provide the alert that the vehicle is not physically sized to fit in the vacant parking space.

Whilst steps S708 and S710 have been described above with reference to the control module 301 providing an alert that the vehicle is or isn't physically sized to fit in the vacant parking space by controlling the light emitted from the light source(s) 302. Embodiments of the present disclosure extend to other methods of providing the alert. For example, in embodiments whereby the luminaire is embodied in a structure external to the vehicle (e.g. in street light 400), the control module 301 may provide the alert by transmission of a signal via the network interface 308 over a wireless network to a mobile device (e.g. smartphone, tablet etc.) of the driver, or to the vehicle utilising an infrastructure-to-vehicle (I2V) communication system. In embodiments whereby the luminaire is embodied in the vehicle itself, the control module 301 may provide the alert by transmission of a signal via the network interface 308 over a wired connection to a computing device (e.g. a navigation unit) on the vehicle.

Whilst step S708, has been described above with reference to the control module 301 providing the alerting that the vehicle is not physically sized to fit in the vacant parking space. In other embodiments, if the control module 301 detects that the vehicle is not sized to fit in the vacant parking space then the control module 301 does not provide an alert—thus in these embodiments, the control module 301 only provides the alert when the vehicle is sized to fit in the vacant parking space.

To prevent a scenario whereby the control module 301 controls the light source(s) 302 (or other alert referred to above) when a vehicle approaches a parking space in the environment of the luminaire 300 that is not intending to park in the parking space, in embodiments described above the control module 301 may receive an additional signal from the dimension supply module 304 that enables the control module to determine whether an approaching vehicle has an intention to park in the parking space, and only in response to determining that the approaching vehicle has an intention to park does the control module 301 operate in accordance with the process 700 described above with reference to FIG. 7.

For example in the context of a car park, control module 301 may receive a signal via the network interface 308, indicating that a vehicle approaching the parking space in the environment of the luminaire has an intention to park, that is transmitted from a sensor external to the luminaire 300 upon this external sensor detecting the vehicle entering the car park.

In another example, the integrated image processing component of at least one camera of the sensor module 306 may detect the speed of a vehicle approaching the space by processing images captured by the at least one camera using known techniques, and supply a signal indicative of the speed of the vehicle to the control module 301. The control module 301 is able to use the signal indicative of the speed of the vehicle to determine whether the vehicle has an intention to park in the parking space. For example, if the speed of the vehicle is less than or equal to a predetermined speed, the control module 301 may determine that the vehicle has an intention to park in the parking space.

In yet another example, the integrated image processing component of at least one camera of the sensor module 306 may observe activation of a parking light, indicator light and/or brake light on the vehicle and supply a signal based on this observation to the control module 301. Based on reception of this signal, the control module 301 is able to determine that the vehicle has an intention to park in the parking space.

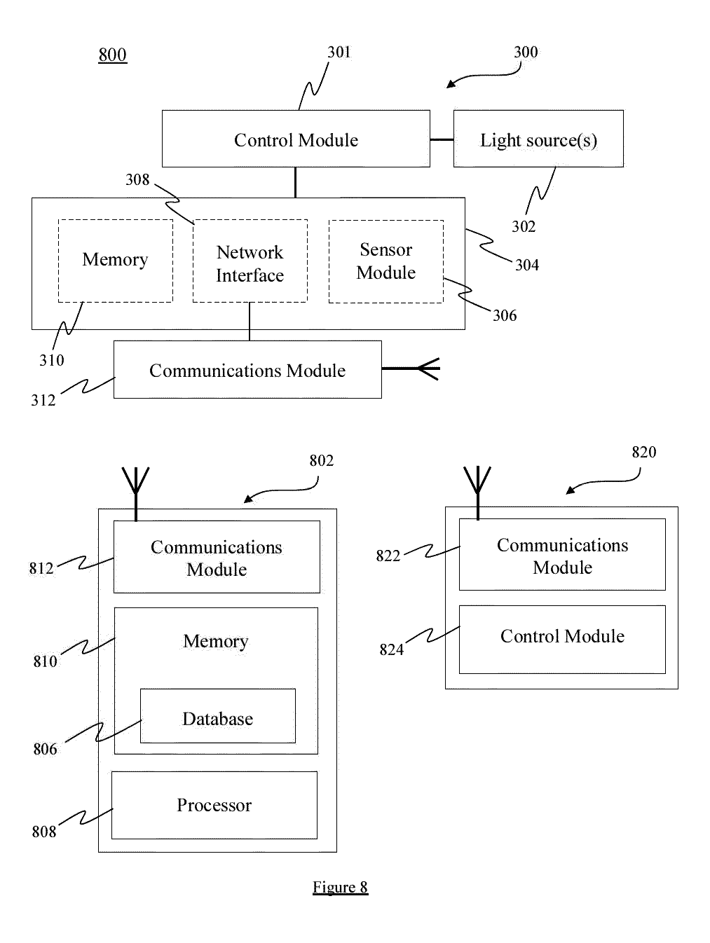

In addition, the system may determine whether the vehicle is authorized to park in the parking space. FIG. 8 illustrates a schematic block diagram of an authorization system 800 which comprises a luminaire 300 and can optionally comprise a base station 802 and an access control center 820.

The luminaire 300 comprises a control module 301 that is coupled to an authorization and dimension supply module 304 and one or more lighting source 302 that are operable to emit light to illuminate an environment of the luminaire 300. The light source(s) 302 may comprise any suitable source of light such as e.g. a high/low pressure gas discharge source, a laser diode, an inorganic/organic light emitting diode (LED), an incandescent source, or a halogen source. A light source may be a single light source, or could comprise multiple light sources, e.g. multiple LEDs which may, for example, form an array of light sources collectively operating as a single light source. The light source(s) 302 are controllable in that the light emitted by the light source(s) 302 is controlled by the control module 301.

The control module 301 is configured to control the light emitted from the light source(s) 302 in response to input signals received from the authorization and dimension supply module 304, by transmitting appropriate control signals to the light source(s) 302.

In accordance with embodiments of the present disclosure the authorization and dimension supply module 304 is configured to supply to the control module 301 the following: (i) identification information for a vehicle approaching a vacant parking space in the environment of the luminaire 300; (ii) authorization information for the vehicle approaching the vacant parking space (iii) dimensions of the vacant parking space; and (iv) dimensions of the vehicle approaching the vacant parking space.

The authorization and dimension supply module 304 may obtain each of the dimensions of the vacant parking space in the environment of the luminaire 300 and the dimensions of a vehicle approaching the vacant parking space to the control module 301 by various means. These are discussed in more detail above.

The authorization and dimension supply module 304 may obtain each of the identification information for a vehicle approaching the vacant parking space in the environment of the luminaire 300 and the authorization information for the vehicle approaching the vacant parking space by various means. These are discussed in more detail below.

The authorization and dimension supply module 304 may comprise a sensor module 306. The sensor module 306 comprises at least one sensor. The sensor module 306 enables detection of the identification information for one or more vehicles approaching the vacant parking space in the environment of the luminaire 300.

The sensor module 306 may comprise one or more optical sensors for example at least one two-dimensional (2D) and/or at least one three-dimensional (3D) camera and/or at least one thermal imaging camera, with an integrated image processing component that executes an algorithm to perform image processing on images captured by the camera.

Identification information for a vehicle approaching a vacant parking space in the environment of the luminaire 300 can be derived from, for example, 2D, 3D, and/or thermal images. For example, a passive 2D Camera can be used to detect identification information for a vehicle within or approaching the environment of luminaire 300. In particular this identifying information can be obtained by applying image processing to captured 2D images. Identifying information captured and/or determined by 2D images include vehicle dimensions, license plate or other visual recognition, and vehicle behaviour, among other possibilities.

The sensor module 306 may comprise multiple 2D cameras having different orientations with respect to each other. Persons skilled in the art will appreciate that processing of the images captured by the multiple 2D camera may enable ambiguities arising due to occlusions to be resolved with or without processing multiple frames captured by each of the multiple 2D cameras. Furthermore a depth image of the scene can be obtained based on images captured by the multiple cameras due to the known orientation relationship between the multiple cameras.

A 3D camera can be used to detect identification information for a vehicle within or approaching the environment of luminaire 300. In particular the identifying information can be obtained by applying image processing to captured depth-aware images. It will be appreciated by persons skilled in the art, that use of a 3D camera may be able to provide more accurate identification information compared with a passive 2D Camera. Among other options, the 3D camera may be a 3D time-of-flight camera comprising a time-of-flight sensing element, a laser scanner or structured light camera (based on the active triangulation principle known in the art), matrix array camera, or any other sensor capable of extracting 3D information. The sensor module 306 may comprise multiple 3D cameras having different orientations with respect to each other.

The sensor module 306 may comprise one or more magnetic sensors, including a field-effect sensor such as a 3-axis Anisotropic MagnetoResistance (AMR) sensor. This type of magnetic sensor can be used to detect identification information for a vehicle approaching a vacant parking space in the environment of the luminaire 300. This identification information can include, for example, one or more vehicle properties such as vehicle dimensions, and/or vehicle behaviour. For example, magnetic signatures detected by a 3-axis AMR sensor can be used to distinguish between different types of vehicle (e.g. car, bus, truck etc.). The sensor module 306 may comprise a memory storing reference vehicle dimensions for each of the detectable vehicle types. Thus once the vehicle type is detected, the sensor module 306 can query the memory for vehicle dimensions associated with the detected vehicle type.

The sensor module 306 may additionally or alternatively comprise one or more radio frequency (RF) receivers or transceivers that enable detection of identification information for one or more vehicles approaching the vacant parking space in the environment of the luminaire 300. For example, the RF receiver of sensor module 306 can receive an RF signal transmitted by the approaching vehicle either continuously, periodically, or in response to a query.

In a vehicle-to-infrastructure (V2I) communications system, the approaching vehicle transmits identifying and/or operational information, and other vehicles, the roadway infrastructure, and the sensor module 306 can receive that transmitted information. Many vehicles are equipped with an RF transceiver configured to transmit information. Alternatively, the vehicle can be retrofitted or otherwise newly equipped with a transponder, such as an RFID transponder, or other device that transmits identifying information.

A smartphone or fob possessed by the driver or a passenger of the approaching vehicle may also include an RF transmitter or transceiver to transmit information using RF. For example, the smartphone or fob may receive a query or ping that prompts it to transmit the information, or the device may periodically or continually transmit the information. Alternatively, the device may comprise a geofence or other system, application, or software that detects its proximity to the luminaire 300 and communicates wirelessly to transmit the identifying information.

The authentication and dimension supply module 304 may comprise a memory 310. The memory 310 may store identifying information for a plurality of vehicles, which has been manually entered by an installer of the luminaire 300. When the authentication and dimension supply module 304 has received the identification information from the approaching vehicle, memory 310 can be queried to determine whether the identified vehicle is authorized to park in the vacant parking space.

Alternatively, the authentication and dimension supply module 304 can communicate with a base station 802 to determine whether the approaching vehicle is authorized to park in the vacant parking space. Accordingly, luminaire 300 may comprise network interface 308 and communications module 312 which enable connection to a wired communication network via a cable (wired) connection and/or enable connection to a wireless communication network via a wireless connection.

Base station 802 can comprise a communications module 812, processor 808, and memory 810 with database 806 which includes information about vehicles that are authorized to park in various parking spaces. Once the authentication and dimension supply module 304 has received the identification information from the approaching vehicle, luminaire 300 can transmit the information to the base station via the network interface 308 and communications module 312, along with or followed by a query asking whether the vehicle is authorized to park in the vacant parking space.

The base station queries the database 806 and provides an answer to the luminaire 300.

If the system determines, based on the received identification information and query response, that the approaching vehicle is authorized to park in the vacant parking spot, the system provides an alert (e.g. to a driver of the vehicle) that the vehicle is authorized to park in the vacant parking space. For example, the control module 301 of the luminaire 300 may control the light emitted from the light source(s) 302 to visually indicate that the vehicle is authorized to park in the vacant parking space. Alternatively, the luminaire 300 and/or base station 802 may provide feedback directly to the vehicle via the V2I infrastructure. The luminaire 300 and/or base station 802 may provide feedback via RF or another wireless signal to the smartphone in order to notify the user. The luminaire 300 and/or base station 802 may control a bollard, gate, or other vehicle control structure. If the vehicle is authorized the access control center 820 may lower or move the bollard, raise the gate, or otherwise allow access to the vacant parking space or its environment. Other methods of notifying or alerting the vehicle and/or user are possible.

According to an embodiment, the luminaire 300 and/or base station 802 communicates with an access control center 820 to provide access to the vacant parking space or its environment. For example, the access control center 820 may control a bollard, gate, or other vehicle control structure. If the vehicle is authorized the access control center 820 may lower or move the bollard, raise the gate, or otherwise allow access to the vacant parking space or its environment.

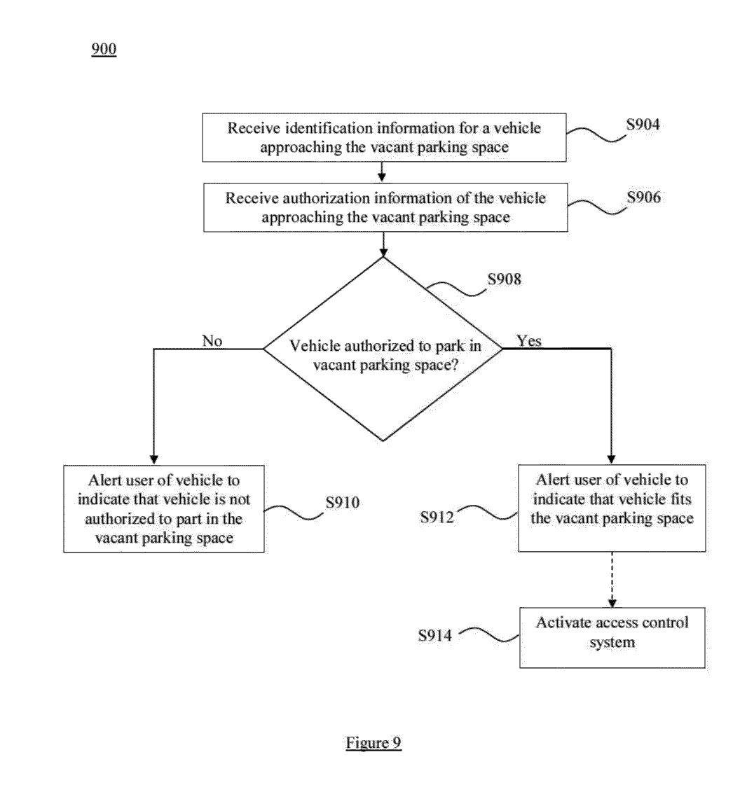

FIG. 9 is a flowchart of a method 900 to provide an alert as to whether a vehicle is authorized to park in a vacant parking space.

At step S904, the luminaire 300 receives identification information for a vehicle approaching of a vacant parking space in the environment of the luminaire. The authentication and dimension supply module 304 may receive the identification information based on a signal received from the sensor module 306 as described above. Alternatively, the authentication and dimension supply module 304 may receive the identification information based on a signal received from the network interface 308 as described above.

At step S906, the luminaire 300 receives authorization information for the vehicle approaching of a vacant parking space in the environment of the luminaire, which may either provide or deny access to the parking space. The authentication and dimension supply module 304 may receive the authorization information based on a signal received from memory 310 as described above. Alternatively, the authentication and dimension supply module 304 may receive the authorization information based on a signal received from the base station 802 as described above.

If the system determines based on the comparison at step S908, that the vehicle is authorized to park in the vacant parking space the process 900 proceeds to step S910, otherwise the process proceeds to step S912.

At step S912, the luminaire 300 provides an alert (e.g. to a driver of the vehicle) that the vehicle is authorized to park in the vacant parking space. For example, the luminaire may control the light emitted from the light source(s) 302 to visually indicate that the vehicle is authorized to park in the vacant parking space. At step 912, the control module 301 may control the colour (hue), colour temperature, and/or intensity of the light emitted by the light source(s) 302. Alternatively or additionally, the control module 301 may control the light source(s) 302 to emit light in accordance with a blinking pattern (whereby one or more of the light source(s) 302 the lights blink on and off in a pattern for a predetermined period of time) indicating that the vehicle is authorized to park in the vacant parking space.

The system may send a wireless notification to the vehicle, user, or user device such as a smartphone or fob indicating that the vehicle is authorized to park in the vacant parking space. Other methods of providing the alert that the vehicle is authorized to park in the vacant parking space are possible.

At step S910, the luminaire 300 may control the light emitted from the light source(s) 302, or send a wireless notification, to indicate that the vehicle is not authorized to park in the vacant parking space.

At optional step S914, the system activates an access control system to provide accces to the vacant parking space or its environment. For example, the luminaire 300 and/or base station 802 may control a bollard, gate, or other vehicle control structure. If the vehicle is authorized the luminaire 300 and/or base station 802 may direct the access control system to lower or move the bollard, raise the gate, or otherwise allow access to the vacant parking space or its environment. The luminaire 300 and/or base station 802 may communicate with an access control center 820 to provide access to the vacant parking space or its environment.

In the above described embodiments, the control module 301 may be further configured to detect a potential collision between the vehicle that the driver is manoeuvring into the parking space and an object in the outdoor environment of the luminaire (e.g. a wall, fence, other vehicle, etc.), and in response, provide an alert (e.g. to the driver of the vehicle) of the potential collision). In embodiments wherein the luminaire 300 comprises a network interface 308, the control module 301 may detect the potential collision based on ADAS data received via the network interface 308 that is transmitted by a transmitter on the vehicle.

In embodiments wherein the luminaire 300 comprises a sensor module 306, the integrated image processing component of at least one camera may detect the potential collision based on image processing on images captured by the at least one camera e.g. that the vehicle is within a threshold distance from an object in the FOV of the camera, and supply a collision signal indicative of the potential collision to the control module 301. Thus the control module 301 is able detect the potential collision based on reception of the collision signal received from the sensor module 306.

The control module 301 may alert the driver of the potential collision by controlling the light emitted from the light source(s) 302 to visually indicate the potential collision. In order to visually indicate the potential collision, the control module 301 may control the colour (hue) of the light emitted by the light source(s) 302. For example, the control module 301 may control the light source(s) 302 such that they emit red light. The control module 301 may control the light source(s) 302 by varying the colour temperature of the light emitted by the light source(s) 302. Alternatively or additionally, the control module 301 may control the intensity of the light emitted by the light source(s) 302. For example, the control module 301 may control the light source(s) 302 to emit light in accordance with a blinking pattern warning the driver of the vehicle of the potential collision.

Embodiments of the present disclosure extend to other methods of controlling the light emitted by the light source(s) 302 that are not described herein to provide the alert of a potential collision.

In embodiments whereby the luminaire is embodied in a structure external to the vehicle (e.g. in street light 400), the control module 301 may provide the alert of the potential collision by transmission of a signal via the network interface 308 over a wireless network to a mobile device (e.g. smartphone, tablet etc.) of the driver, or to the vehicle utilising an infrastructure-to-vehicle (I2V) communication system. In embodiments whereby the luminaire is embodied in the vehicle itself, the control module 301 may provide the alert of the potential collision by transmission of a signal via the network interface 308 over a wired connection to a computing device (e.g. navigation unit) on the vehicle.

In the embodiments described above, the control module 301 may be configured to transmit, via the network interface 308, information of free parking slots and vehicle dimensions to a remote parking management and/or navigation systems. This high level information can then be used to optimize the allocation of parking spaces based on the dimensions of vehicles.

Whilst embodiments have been described above with reference to providing an alert to a user (e.g. driver) present in the vehicle, embodiments extend to providing an alert to a fully autonomous vehicle (often referred to as a driverless vehicle or self-driving vehicle) whereby no human is present in the vehicle.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A luminaire comprising:
a control module;
at least one light source arranged to emit light to illuminate an outdoor environment of the luminaire; and
a dimension supply module comprising a sensor module and configured to supply (i) dimensions of a vacant parking space in said environment to the control module; and (ii) dimensions of a vehicle approaching the vacant parking space to the control module, wherein the sensor module is configured to detect the dimensions of the vacant parking space and the dimensions of the vehicle;
wherein the control module is configured to compare the dimensions of the vacant parking space and the dimensions of the vehicle to determine whether the vehicle is physically sized to fit in the vacant parking space, and if so, provide an alert that the vehicle is physically sized to fit in the vacant parking space.

2. A luminaire according to claim 1, wherein the sensor module comprises one or any combination of:
at least one three-dimensional camera;
at least one two-dimensional camera; and
at least one thermal imaging camera.

3. A luminaire according to claim 2, wherein the sensor module further comprises an Anisotropic MagnetoResistance sensor configured to detect the dimensions of the vehicle.

4. A luminaire according to claim 1, wherein the dimension supply module comprises a network interface for reception over a communication network of at least one of the dimensions of the vacant parking space and the dimensions of the vehicle.

5. A luminaire according to claim 4, wherein the network interface comprises a wireless network interface, and the control module is configured to provide the alert by transmission of a signal via a wireless communication network to the vehicle or a mobile device associated with a user of the vehicle.

6. A luminaire according to claim 1, wherein the control module is configured to provide the alert by controlling the light emitted from the at least one light source to visually indicate that the vehicle is physically sized to fit in the vacant parking space.

7. A luminaire according to claim 1, wherein the dimension supply module is further configured to supply (iii) identification information for the vehicle approaching the vacant parking space; and (iv) authorization information for the vehicle approaching the vacant parking space to the control module, wherein the sensor module is further configured to detect the identification information.

8. A luminaire according to claim 1, wherein the control module is configured, in response to a determination that the vehicle is not physically sized to fit in the vacant parking space, to provide an alert that the vehicle is not physically sized to fit in the vacant parking space.

9. A luminaire according to claim 1, wherein the control module is configured to detect a potential collision between the vehicle and an object in the outdoor environment of the luminaire, and in response, provide an alert of the potential collision.

10. A luminaire according to claim 1, wherein the dimension supply module comprises a memory storing the dimensions of the vacant parking space.

11. A luminaire according to claim 1, wherein the dimension supply module comprises a memory storing the dimensions of the vehicle.

12. A street light comprising:
a pole; and
the luminaire according to claim 1, wherein the luminaire is mounted to said pole.

13. (canceled)

14. (canceled)

15. (canceled)
